(19) United States
(12) Patent Application Publication
(10) Pub. No.: US 2003/0144164 A1
(43) Pub. Date: Jul. 31, 2003

(54) Method and composition for removing organic coatings from a substrate

(75) Inventors: John F. Pilznienski, Dearborn Heights, MI (US); James C. Malloy, Ferndale, MI (US)

Correspondence Address: DRIGGS, LUCAS, BRUBAKER & HOGG CO. L.P.A, DEPT. KOL, 8522 EAST AVENUE, MENTOR, OH, 44060, US

(73) Assignee: Kolene Corporation, Detroit, MI

(21) Appl. No.: 10/058,675

(22) Filed: Jan. 29, 2002

(51) Int. Cl. C23G 1/00; C23D 17/00; B08B 3/00; B08B 7/00; F23J 1/00; C03C 23/00; C11D 1/00; C09D 9/04

(52) U.S. Cl. 510/177; 134/38; 134/2; 134/19; 134/26; 134/30; 134/34; 510/178; 510/201; 510/499

(57) ABSTRACT

A method and composition for removing organic coatings or residues from a substrate is provided, which composition includes an organic carrier of ethanolamines and non-ionic alkylphenol ethoxylate surfactants and mixtures thereof and potassium hydroxide and being free of water.

In use, the composition is formed by mixing the ethanolamines and the surfactants and adding the potassium hydroxide. The composition is maintained above the boiling point of water in liquid state, preferably from about 225° F. to about 350° F., and the workpieces having organic coatings or residues thereon, are immersed in the heated composition.

If the composition is maintained essentially free of water, the alkali metal hydroxide will not attack substrates that would normally be attacked by alkali metal hydroxides when sufficient water is present to ionize the potassium hydroxide, such as zinc, aluminum and magnesium.

### BACKGROUND OF THE INVENTION

The removal of organic coatings or residues from a substrate and particularly the removal of such organic coatings or residues as greases, oils, mold release coatings, polyester coatings, epoxy coatings, paints and other types of coatings, is extremely important in many industries. In particular, organic coatings or residues need to be removed from metallic substrates either for the re-working of a part which has a flawed coating or for reclaiming parts in which the substrate is intact but which requires residues to be removed and/or new coatings to be applied.

It is known that a caustic compound in an aqueous base is very effective to remove many types of organic coatings and residues from many types of metal substrates. However, it is known that certain metals, such as zinc, aluminum and magnesium or metallic coatings comprised of these metals or alloys thereof, as well as other metals and alloys are subject to chemical attack in such caustic solutions and, thus, such caustic material is to be avoided according to prior art teachings when removing coatings from such metals as aluminum, magnesium and zinc. One particular approach, which avoids the use of such caustic and specifically teaches the avoidance of such caustic, is to use triethanolamine and an alkylphenol ethoxylate surfactant at elevated temperatures up to 350° F. for removing such coatings. While such materials are somewhat effective on certain coatings, nevertheless they are slow and, in the case of certain coatings, are not effective to remove the coating, even with post treatment of rinsing and pressure spraying. Therefore, it is desirable to find a composition and method which will remove organic coatings from substrates, specifically substrates which are formed of zinc, aluminum or magnesium or their alloys, or other materials without attacking the substrates, and which method and composition are also useful for removing coatings from other substrates.

### SUMMARY OF THE INVENTION

According to the present invention, a method and composition for removing organic coatings or residues from a substrate is provided. The composition includes an organic carrier selected from the group of ethanolamines and non-ionic alkylphenol ethoxylate surfactants and mixtures thereof and includes potassium hydroxide. The composition is further characterized by being essentially free of water or having a water content low enough so the hydroxide is not ionized to an extent that it will attack zinc, aluminum or magnesium substrates. Thus, as used herein, the term “essentially free of water” means water content at a level which will not ionize the potassium hydroxide to such an extent it will attack aluminum, magnesium or zinc substrates.

In use, the composition is formed by mixing the ethanolamines and the surfactants and adding the potassium hydroxide. The potassium hydroxide may be added either in solid form or as an aqueous solution of potassium hydroxide. If added in solid form, the resulting composition does not require heating to drive off any excess water. If added in aqueous liquid form, the composition may have to be heated to above the boiling point of water to drive off any excess of water depending upon the amount of water added with the potassium hydroxide. The time required to boil off the water is a function of temperature, surface area of the vessel or tank, and the amount of water content initially in the composition, it being understood that the higher the temperature, the less time required to boil off the water, and the greater the amount of water contained, the longer the time it will take to remove the water. The composition is maintained above the boiling point of water in liquid state, preferably from about 225° F. to about 350° F., and the workpieces having organic coatings or residues thereon, which are to be removed, are immersed in the heated composition. Due to the hygroscopicity of the ethanolamines and potassium hydroxide, it may also be necessary to drive off excess water which may become absorbed by the solution during extended times at ambient or low temperatures. The time required in the composition varies depending upon the particular coating or residue being treated, the thickness of the coating or residue, the potassium hydroxide content of the composition, the operating temperature of the composition, and the make-up of the carrier. This may be as little as a few minutes to as much as several hours depending upon the nature of the coating, the thickness thereof and the uniformity of the coating. When the substrate with the treated coating is removed from the bath, a post treatment, such as a water rinse or water spray, may be performed to remove any vestiges of the coating or residue left. In some cases, however, such post treatment is not necessary.

It has been found that, if the composition is maintained essentially free of water, the alkali metal hydroxide will not attack substrates that would normally be attacked by such alkali metal hydroxides when sufficient water is present to ionize the potassium hydroxide, such as zinc, aluminum, magnesium and other such metals and alloys thereof. Thus, while the composition may be used to remove coatings on substrates other than metals which are susceptible to attack by potassium hydroxides when sufficient water is present to ionize the potassium hydroxide, it is particularly useful for removing coatings and residues from such substrates, such as aluminum, magnesium and zinc or alloys thereof which are susceptible to such attack by potassium hydroxides without such attack occurring when the composition is maintained essentially free of water.

### DESCRIPTION OF THE PREFERRED EMBODIMENTS

It has been found that potassium hydroxide if maintained in an organic carrier, such as ethanolamines or non-ionic alkylphenol ethoxylate surfactants or mixtures thereof, and essentially free of water when maintained at elevated temperatures, particularly between about 225° F. and about 350° F., is very effective for removing organic coatings and/or residues from substrates. Particularly, such a composition will not etch or otherwise damage substrates, such as zinc, aluminum, magnesium and alloys thereof, that are normally damaged by potassium hydroxide when sufficient water is present to ionize the potassium hydroxide. Even chromate coatings on zinc or aluminum substrates are virtually unaffected. Thus, while the composition is useful for removing organic compositions from many different substrates, it is especially useful in removing organic coatings or residues from substrates which are normally attacked by potassium hydroxide in the presence of water, such as zinc, aluminum, magnesium or alloys thereof.

A carrier for the potassium hydroxide preferably is an ethanolamine, and a particularly useful ethanolamine is triethanolamine (TEA), although monoethanolamine (MEA) or diethanolamine (DEA) or mixtures of TEA, MEA and DEA may also be used and/or a non-ionic alkylphenol ethoxylate. This is a non-ionic, nonylphenol surfactant. A particularly useful surfactant is Surfonic N-60 sold by Huntsman Corporation, although Surfonic N-95 and Surfonic N-40 or mixtures of N-60, N-95 and N-40 may be used. (In this designation, the N designates the hydrophobe as nonylphenyl, and the number (i.e. 60, 95 or 40) indicates a ten-fold multiple of the molar ratio of ethylene oxide to the hydrophobe.) The Surfonic N-60 is preferred since it has reduced foaming properties, and also acts to lower the freezing point of the carrier. To this composition is added potassium hydroxide. It has been found that the maximum solubility of potassium hydroxide in such a carrier is about two percent (2%) in the essentially anhydrous state. Further, it has been found that, at treating temperatures of from about 225° F. to 350° F., as low as one percent (1%) potassium hydroxide is very effective in removing organic coatings. The potassium hydroxide also acts to lower the freezing point of the composition.

If the amount of potassium hydroxide falls below one percent (1%), there is a decrease in the effectiveness of the coating or residue removal by the composition. If more than about two percent (2%) potassium hydroxide is present, it remains as an insoluble precipitate in the essentially anhydrous state but it may be dissolved as the potassium hydroxide is depleted from the carrier. The potassium hydroxide can be added either in solid form or as an aqueous solution. Preferably, the aqueous solution contains forty-five percent (45%) potassium hydroxide water solution, a readily available commercial solution. If the solution of potassium hydroxide is added such that there is a resultant amount of potassium hydroxide in the composition of about two percent (2%) or less, the water does not need to be “boiled” off, and the composition can be heated to operating temperatures of between about 225° F. and 350° F., and used immediately for removal of coatings or residues. While temperatures of between 225° F. and 350° F. can be used, preferably the temperatures are between about 300° F. and 350° F. If there is more than about two percent (2%) potassium hydroxide added by aqueous solution of forty-five percent (45%) potassium hydroxide, it is necessary that the composition be heated above about 212° F. to have the excess water removed. By this, it is meant that a test for water, such as a Carl Fisher titration, determines the amount of water present and through correlation with actual experimental trials with test coupons, determine “go—no go” water content levels. As a practical matter, what is required is that the water be reduced to a sufficiently low value that will not allow the potassium hydroxide to sufficiently ionize in the water and, thus, attack a metal substrate. As a practical matter, this amounts to no more than about two percent (2%) water when the composition is made up which, as indicated above, needs to be essentially free of water at operating temperature. Thus, when making up the bath and heating it to the temperature at which it is to be used, it is necessary to be sure that essentially all water hydration or water solution that was present be driven off to an extent to provide a resultant water content which will not ionize the potassium hydroxide. This value can be determined by conventional testing, such as Carl Fisher titration, or by running simple test coupons, which may be as simple as common aluminum foil, although in practice it will become apparent, after a certain period of time of heating of the composition, that essentially all of the water has been driven off.

As indicated above, the composition loses its effectiveness if the amount of potassium hydroxide drops below about one percent (1%). Thus, if during operation the potassium hydroxide drops below one percent (1%), additional potassium hydroxide can be added if no additional carrier is necessary. This can be added in brick form or solid form or indeed can be added as an aqueous solution of potassium hydroxide. The hydroxide can also be added as a high concentration of potassium hydroxide, e.g. up to fifty percent (50%) or greater in the carrier or a component of the carrier. However, an optimum make-up composition is sixty percent (60%) triethanolamine and forty percent (40%) of forty-five percent (45%) aqueous solution of potassium hydroxide. However, once it is added, if there is any water contained as water hydration or water solution, this must be driven off before the bath can again be used for removing coatings from the surfaces of reactive metal substrates. The amount of potassium hydroxide contained in the composition can be determined by conventional acid/base titration utilizing standardized hydrochloric acid and a pH meter to the desired end point. The required addition to restore bath activity can be calculated from the following formula:

The KOH content in a TEA and surfactant mixture may be determined by:

obtaining a 30 ml sample of the solution;

diluting with about 400 mls of water;

titrating it with standardized hydrochloric acid to an endpoint of pH 10.2 as indicated by a pH meter, and

calculating as follows:

[ml(acid)×N(acid)]/6=wt % KOH

The required addition also may be determined from a look-up table constructed by known factors and relationships, as is well known in the art.

Various types of articles having various substrates on which the present invention is particularly effective include painted or coated galvanized steel items, painted or coated zinc die-cast items, highly polished brass hardware with various organic clear coat finishes, coated or painted aluminum hardware and components, including highly polished automotive tire rims, and aluminum engine castings including heads, blocks, timing chain covers, and other similar parts of the engine, which are soiled with oils, carbon, oil sludge or road grime, gaskets, sealants and other types of organics. The articles being stripped of coatings or residues are immersed in the composition at a temperature above about 212° F., preferably between about 225° F. and 350° F., and more preferably between about 300° F. and 350° F. The articles are left in the heated composition for enough time to either remove the coatings or residues completely or loosen them enough for them to be completely removed by post treatments of rinsing or spraying with water. This may be just a few minutes, up to several hours; however, normally most coatings or residues can be so removed with minimum times between about fifteen minutes and sixty minutes. Moreover, proportions of the carrier ingredients can be varied to optimize results on various types of coatings or residues.

The optimum ratio of the ethanolamines to alkylphenol ethoxylates as a carrier for the potassium hydroxide varies depending upon which coating or residue is being removed. For example, from a 50-50 mixture of ethanolamines and alkylphenol ethoxylates to one hundred percent (100%) ethanolamines is the most effective for removing residues, such as carbonized material and other such soils or residues, and silicone mold release from bread pans, especially galvanized steel bread pans. Conversely, the optimum ratio of the ethanolamines to the alkylphenol ethoxylates as a carrier for the potassium hydroxide varies from a 50-50 mixture to 100 percent (100%) of the alkylphenol ethoxylate for removing paints and other acrylics, epoxy and such coatings. Simple experimentation will reveal the correct mixture.

As a general rule, as the TEA ratio to surfactant is reduced, the caustic-free formulations became less effective, while the caustic containing formulations become more effective with certain types of coatings, and soil such as carbonized materials and mold release coatings. It is also instructive to note that a test of the surfactant alone showed that there is no coating removal capability, while the same surfactant under the same conditions to which potassium hydroxide was added performed very well. This indicates that while the TEA is itself somewhat active as a cleaner, the surfactant alone is not. In addition to caustic, the potassium hydroxide appears to be a more reactive agent that requires a carrier or vehicle that prevents ionization or disassociation of the hydroxide and, thus, prevents any subsequent attack on the metal substrate. Also, the addition of alkali metal silicate to the composition exhibits some benefit in cleaning soil or other residue from certain substrates.

What is claimed is:

1. A composition for removing organic coatings from a substrate comprising:
a) an organic carrier selected from the group of:
1) ethanolamines, and mixtures thereof, and
2) non-ionic, nonylphenol surfactants, and mixtures thereof; and
3) mixtures of 1) and 2);
b) potassium hydroxide;
c) said composition being further characterized by being essentially free of water.

2. The composition of claim 1 further characterized by said surfactant being an alkylphenol ethoxylate or mixture thereof.

3. The invention as defined in claim 1 wherein said potassium hydroxide is present in an amount of at least one percent (1%) by weight.

4. The invention as defined in claim 1 wherein the carrier includes triethanolamine.

5. The invention as defined in claim 4 wherein there is between about one percent (1%) and about two percent (2%) potassium hydroxide.

6. The invention as defined in claim 1 wherein the carrier comprises triethanolamine and an alkylphenol ethoxylate, and the composition has about two percent (2%) potassium hydroxide.

7. The invention as defined in claim 1 wherein said carrier is comprised of triethanolamine and the composition has about two percent (2%) potassium hydroxide.

8. The invention as defined in claim 1 wherein said carrier is comprised of alkylphenol ethoxylate, and the composition has about two percent (2%) potassium hydroxide.

9. A method of stripping an organic coating or residue from a metal substrate comprising the steps of:
1) providing a composition comprising:
a) an organic carrier selected from the group of:
i) ethanolamines, and mixtures thereof, and
ii) non-ionic, nonylphenol surfactants, and mixtures thereof; and
iii) mixtures of i) and ii);
b) potassium hydroxide;
c) said composition being further characterized by being essentially free of water;
2) maintaining the composition above 212° F.; and
3) immersing said coated substrate in said solution at said elevated temperature.

10. The invention of claim 9 further characterized by said surfactant being an alkylphenol ethoxylate or mixture thereof.

11. The invention as defined in claim 9 wherein said potassium hydroxide is present in an amount of at least one percent (1%) by weight.

12. The invention as defined in claim 9 wherein the carrier includes triethanolamine.

13. The invention as defined in claim 12 wherein there is between about one percent (1%) and about two percent (2%) potassium hydroxide.

14. The invention as defined in claim 9 wherein the carrier comprises triethanolamine and an alkylphenol ethoxylate, and the composition has about two percent (2%) potassium hydroxide.

15. The invention as defined in claim 9 wherein said carrier is comprised of triethanolamine and the composition has about two percent (2%) potassium hydroxide.

16. The invention as defined in claim 9 wherein said carrier is comprised of an alkylphenol ethoxylate, and the composition has about two percent (2%) potassium hydroxide.

17. The invention as defined in claim 9 wherein said composition is maintained between about 225° F. and about 350° F.

18. The invention as defined in claim 9 wherein the composition is maintained between about 300° F. and 350° F.

19. The invention as defined in claim 9 wherein said metal substrate is selected from the group of aluminum, magnesium, zinc and alloys thereof.

20. The invention as defined in claim 19 wherein said organic coating is selected from the group of silicones, acrylics, polyesters, and epoxies.
